(19) United States
(12) Patent Application Publication
(10) Pub. No.: US 2009/0275346 A1
(43) Pub. Date: Nov. 5, 2009

(54) System and Method for Predictive Caching of Data for a Mobile Computing Device

(75) Inventors: Amanda J. Bauman, Austin, TX (US); Brian D. Bauman, Austin, TX (US); Michael P. Carlson, Austin, TX (US); Michael L. Masterson, Cedar Park, TX (US)

Correspondence Address: Greg Goshorn, P.C., 9600 Escarpment, Suite 745-9, AUSTIN, TX, 78749, US

(73) Assignee: International Business Machines Corporation, Armonk, NY (US)

(21) Appl. No.: 12/113,979

(22) Filed: May 2, 2008

(51) Int. Cl. H04Q 7/20

(52) U.S. Cl. 455/456.2

(57) ABSTRACT

Provided is a method for providing data buffering at a wireless communication nodes. Communication nodes maintain data buffering capabilities so that a data cache related to a particular mobile computing device is forwarded among communication nodes in anticipation the movement of the mobile computing device. A decision to forward a specific data cache associated with a particular mobile computing device to a particular end relay communication node is based upon the type, history or other knowledge of the data, knowledge of communication node configuration and/or knowledge of the particular mobile computing device. Intelligent predictions of advantageous buffer forwarding are employed to transmit data caches over high-speed connections between communication nodes to mitigate data buffering issues relating to the transmission of large amounts of data over slower end links between communication nodes and end user devices.

### BACKGROUND

1. Technical Field

The claimed subject matter relates generally to mobile computing devices and, more specifically, to a method for increasing the speed at which data is delivered to mobile computing devices.

2. Description of the Related Art

Over the last couple of decades, computing devices have become both more powerful and more mobile. The increase in power enables devices such as cellular telephones and palm computers to process and deliver increasingly large amounts of data, or content. Such content may include such things as internet-provided materials and radio television signals. Of course, the delivery of more content often creates issues associated with the mobility of the device; i.e. more content typically demands more communication bandwidth.

Mobile communication systems such as cellular telephone and WiFi systems rely upon connections among backend content servers, communication nodes and a transmitting and receiving device, or end node. Providing additional capacity among communication nodes and various backend data servers can be straightforward but the link between a particular node and an end user's device, or the “end node.” is more problematic. Although the capacity of end nodes has increased and continues to increase, this rate of increase has not necessarily kept pace with either the increase data capacity among communication nodes and servers or an increase in demand by mobile computing devices.

Some mobile devices address the end node data bottleneck by data buffering. In other words, content is not presented to the end user until a certain amount of data, or a buffer, has already been transmitted. Although buffering techniques address issues related to the initial delay associated with the transmission of data and periods of low throughput on an end link, even with data buffering, a mobile computing device may experience period in which content delivery must be paused to enable the transmission of content to catch up with the presentation of the content. Typically, the mobile computing device pauses the presentation to enable additional content buffering to occur. In addition, data buffering issues frequently arise when a mobile computing device is executing a transition between two different communication nodes, such as but not limited to cellular towers, wireless internet service providers (ISPs) and WiFi “hot spots.”

In the example of cellular telephone systems and other wireless systems, a particular communication device may exchange service messages with multiple communication nodes, particularly during call setup and while making a determination of the end node's geographical position. In addition, a particular communication may be relayed from communication node to communication node before arrival at a switching node, i.e. via intermediate relay nodes. However, actual communication between an end user and a connected party or server at any specific time is relayed to the end node via one communication node. For the sake of clarity, the node that is the final link for actual communication between parties at any specific point in time is referred to as the “end relay communication node” to distinguish it from the end node and other communication nodes, including any intermediate relay nodes.

Currently, data buffering with respect to the delivery of content is primarily performed on the end user's mobile computing device, or end node, rather than at the communication nodes or the content server.

### SUMMARY OF THE CLAIMED SUBJECT MATTER

Provided is a method for providing data buffering at a communication node, such as, but not limited to, a cellular telephone tower, a WIFI hot spot or a wireless ISP, which supports wireless devices. Communication nodes maintain data buffering capabilities so that a data cache related to a particular mobile computing device, or end node, is forwarded among communication nodes in anticipation the movement of the mobile computing device. A decision to forward a specific data cache associated with a particular mobile computing device to a particular end relay communication node is based upon the type, history or other knowledge of the content buffered, knowledge of communication node configuration and/or knowledge of the particular mobile computing device. Knowledge of the computing device may include, but is not limited to, information related to geographical location and likely travel, or “roaming,” patterns. Intelligent predictions of advantageous buffer forwarding are employed to transmit data caches over high-speed connections between communication nodes to mitigate data buffering issues relating to the transmission of large amounts of data over slower end links between communication nodes and end user devices.

In an alternative embodiment, data caches are transmitted to either all or selected end relay communication nodes that border the end relay communication node in use by a particular mobile computing device. When a mobile computing device roams from the service of one end relay communication node to the service of another, signaling among nodes enables selected sites to delete any caches that are unlikely to be used. Buffers may also include expiration times so that a cache that has not been accessed after a specified period of time is deleted.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures, in which:

FIG. 1 is a block diagram of one possible mobile computing architecture that employs the claimed subject matter.

FIG. 2 is a block diagram of a cellular system, first introduced in conjunction with FIG. 1, in more detail.

FIG. 3 is a block diagram of a predictive switching logic (PSL) server module, first introduced in conjunction with FIG. 2, in more detail.

FIG. 4 is a block diagram of a predictive switching logic (PSL) client module, first introduced in conjunction with FIG. 2, in more detail.

FIG. 5 is a flowchart of a Monitor Call process executed by the PSL server module of FIGS. 2 and 3.

FIG. 6 is a flowchart of an Analyze Mobile process executed by the PSL server module of FIGS. 2 and 3.

FIG. 7 is a flowchart of a Cleanup Buffer process executed by the PSL server module of FIGS. 2 and 3 and the PSL client modules of FIGS. 2 and 4.

### DETAILED DESCRIPTION OF THE FIGURES

Although described with particular reference to a cellular telephone system, the claimed subject matter can be implemented in any information technology (IT) system in which wireless roaming is implemented. Those with skill in the computing arts will recognize that the disclosed embodiments have relevance to a wide variety of computing environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for caching data at multiple wireless communication nodes. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

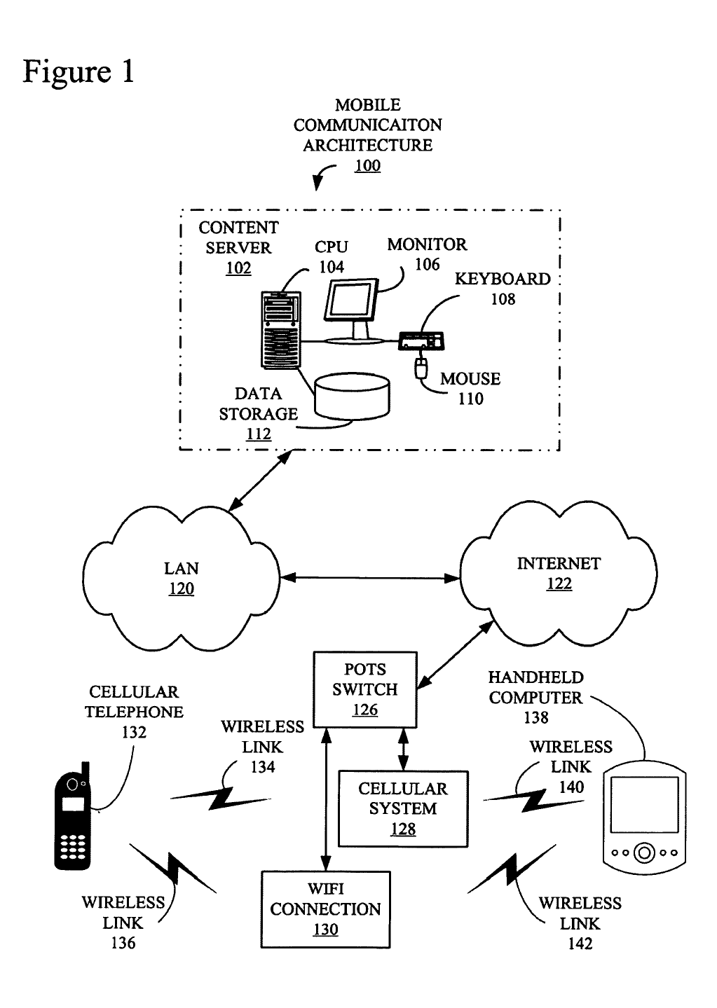

Turning now to the figures, FIG. 1 is an example of a mobile communication architecture 100, implemented according to the claimed subject matter. It should be noted that architecture 100 is only one example of a configuration in which the claimed subject matter may be implemented. Those with skill in the computing and communication arts should appreciate that there are many types of devices and communication and computing environment that may be incorporated into such a system.

Architecture 100 includes a computing system, or “content server.” 102. Content server 102 includes a central processing unit (CPU) 104, coupled to a monitor 106, a keyboard 108 and a mouse 110, which together facilitate human interaction with server 102. Also included in computer 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

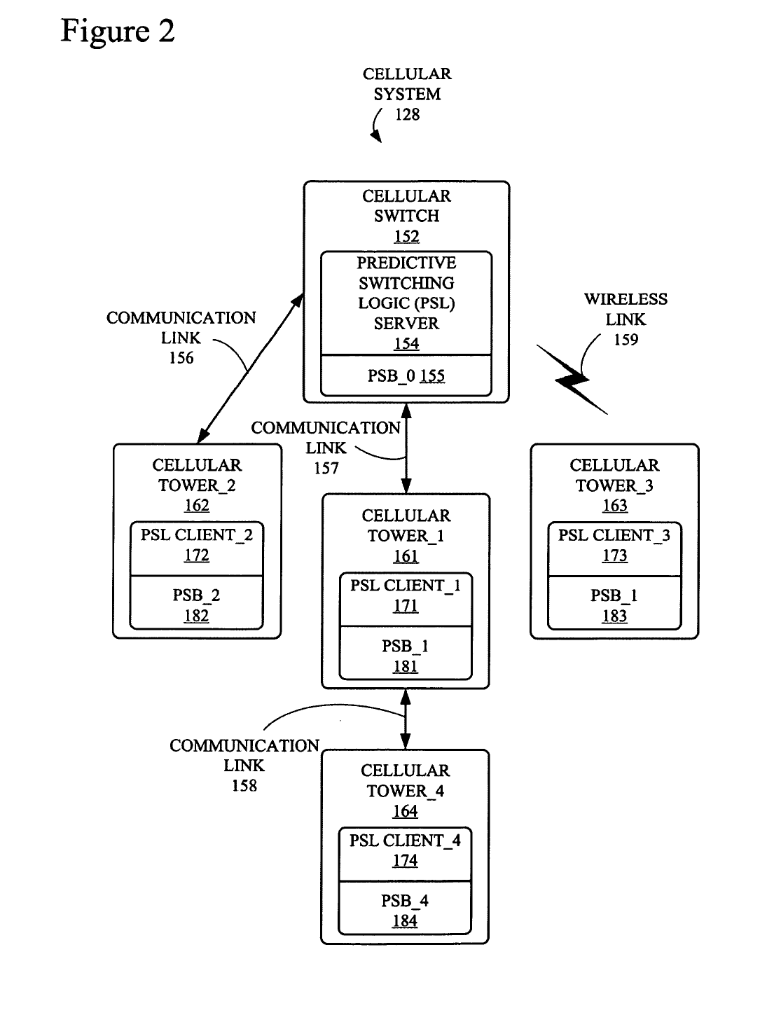

Server 102 is communicatively coupled to a local area network (LAN) 120. LAN 120 is coupled to the Internet 122. Also connected to Internet 122 is a plain old telephone switch (POTS) 126. A cellular system 128 and a WiFi connection 130 are coupled to POTS 126 and, via POTS 126, to Internet 122. In this example, two mobile communication/computing devices, i.e. a cellular telephone 132 and a handheld computer 138, are both able to communicate with cellular system 128 and WiFi connection 130. Cellular system 128 is described in more detail below in conjunction with FIG. 2.

Wireless link 134 represents a communication link, or “end link.” between cellular telephone 132 and cellular system 128. Wireless link 136 represents a communication link between cellular telephone 132 and WiFi connection 130. Typically, only one of links 134 and 136 is active for actual user communication, although, as explained above in the Background, multiple links may be actively carrying service message communication. Cellular telephone 132 “roams” between links 134 and 136, as well as other possible communication links, which for the sake of simplicity are not shown. Cellular telephone 132 selects which of links 134 or 136 to utilize for user communication based upon preconfigured parameters. For example, telephone 132 may select the link 134 or 136 based either upon the strength of the connection or the relative costs of the connections 134 and 136.

Wireless link 140 represents a communication link between handheld computer 138 and cellular system 128. Wireless link 142 represents a communication link between handheld computer 138 and cellular system 130. Typically, only one of links 140 and 142 is active for actual user communication. Like telephone 132, handheld computer 138 “roams” between links 140 and 142, as well as other possible communication links, which for the sake of simplicity are not shown, and selects which of links 140 or 142 to utilize for user communication at any particular time based upon various parameters.

Although the disclosed technology is applicable to any mobile computing device and any type of communication system, the following description employs cellular telephone 132, cellular system 128 and content server 102 for the purposes of illustration. Those with skill in the computing and communication arts should appreciate that the claimed subject matter may be applied to a large variety and configurations of communication systems in addition to those illustrated and described.

FIG. 2 is a block diagram of cellular system 128, first introduced in conjunction with FIG. 1, in more detail. Cellular system 128 includes a cellular switch 152 and four (4) communication nodes, or cellular towers, i.e. a cellular tower_1 161, a cellular tower_2 162, a cellular tower_3 163, and a cellular tower_4 164. Cellular switch 154 communicates with cellular towers 161-164 via three hard-wired links 156-158 and one (1) wireless communication link 159 (FIG. 1). It should be noted that links 156-159, regardless of whether they are wired or wireless, would typically be much faster and a higher capacity than links, such as links 134 and 136 (FIG. 1). The specific makeup and configuration of communication links 156-159 are used for illustrative purposes only; one with skill in the communication arts would appreciate that many types of communication links and configurations could be utilized in an implementation of the claimed subject matter.

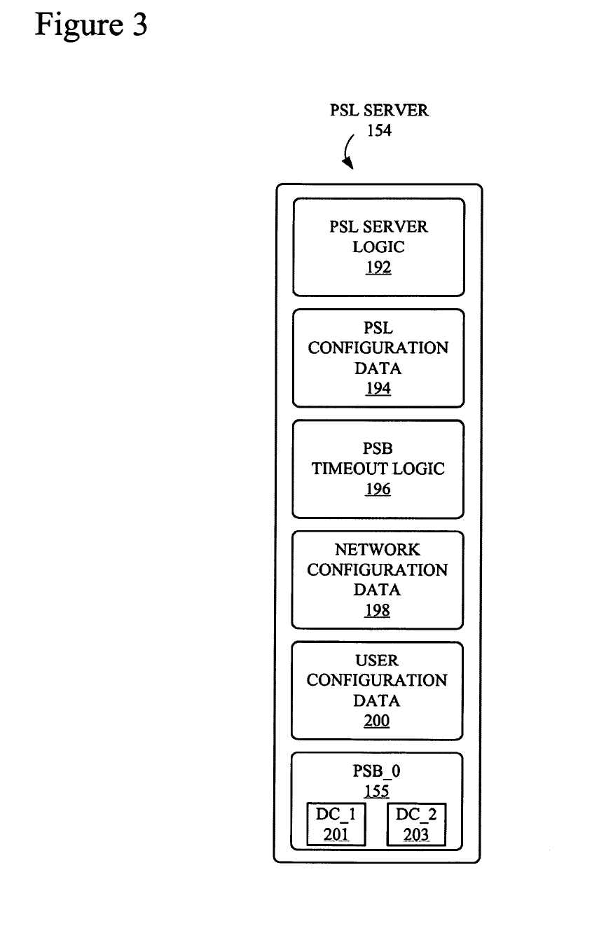

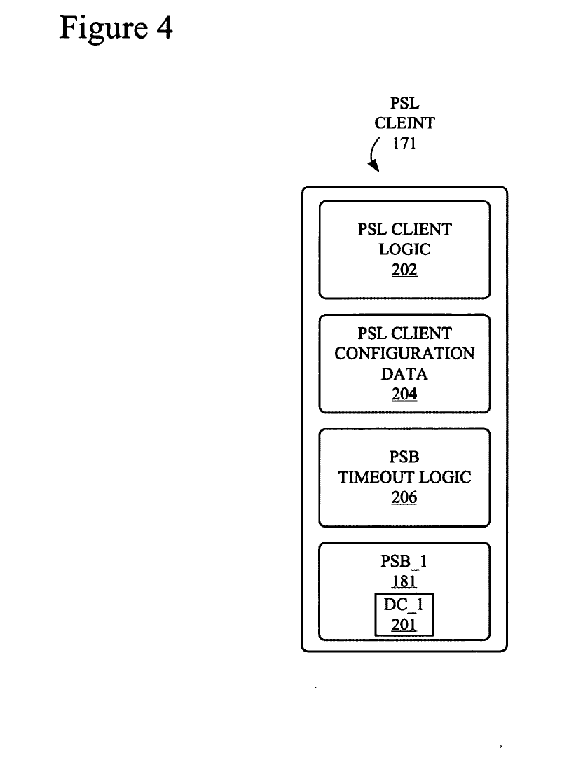

Cellular switch 152 includes a predictive switching logic (PSL) server module 154, which includes a predictive switching buffer, i.e. PSB_0 155. Cellular towers 161-164 each include a PSL client module, i.e. a PSL client_1 171, a PSL client_2 172, a PSL client_3 173 and a PSL client_4 174, respectively. PSL clients 171-174 each include a predictive switching buffer, i.e. a PSB_1 181, a PSB_2 182, a PSB_3 183 and a PSB_4 184, respectively. PSL server 154 and PSB_0 155 are described in more detail below in conjunction with FIG. 3. PSL clients 171-174 and PSBs 181-184 are described in more detail below in conjunction with FIG. 4. In an alternative embodiment, instantiations of PSL server module 154 are stored and executed at communication towers 161-164 rather than switch 152. It should be noted that for any specific connection between cellular telephone 132 (FIG. 1) and cellular system 128 only one cellular tower 161-164 would be transmitting and receiving actual user communication from telephone 132. The specific node handling user communication is referred to as the “end relay communication node.”

FIG. 3 is a block diagram of the predictive switching logic (PSL) server module 154, first introduced in conjunction with FIG. 2, in more detail. In the following example, PSL server module 154 is incorporated into cellular switch 128 and executes on computing logic associated with cellular switch 128 to implement particular aspects of the claimed subject matter. PSL server 154 includes a PSL server logic module 192, a PSL Configuration Data module 194, a PSB Timeout Logic module 196, a Network Configuration Data module 198, a user configuration data module 200 and PSB_0 155 (FIG. 2).

PSL server logic module 192 controls the implementation of the claimed subject matter and transmits instructions and data to PSL clients 171-174 (FIG. 2). For example, module 192 executes code to both predict the need for a data cache corresponding to, in the following example, cellular telephone 132 (FIG. 1) and, once a need is identified, transmit the data cache to the appropriate end relay communication node, such as cellular towers 161-163 (FIG. 2). The operation of PSL logic module is described in more detail below in conjunction with FIGS. 4-7.

PSL configuration data module 194 stores information, or parameters, associated with a particular implementation of the claimed subject matter. One example of a parameter stored in conjunction with data 194 is a timeout parameter. The timeout parameter specifies an interval of time that is required to pass before a PSB timeout logic module 198 deletes a particular data cache. The timeout parameter may be applicable to data caches either only on cellular switch 152 or throughout cellular system 128 (FIGS. 1 and 2). Module 194 also stores such information as, but not limited to, related to optimal buffer cache size.

Network configuration data module 198 stores information related to the configuration of cellular system 128. Information includes, but is not limited to, data about cellular tower locations and the handoff characteristics of the system 128. For example, module 198 may store information that indicated cellular tower_1 161 (FIG. 2) is located in proximity, and executes the handoff of ongoing telephone calls with, cellular tower_2 162 (FIG. 2) cellular tower_3 163 (FIG. 2) and cellular tower_4 164 (FIG. 2). The use of the information stored in module 198 is explained in more detail below in conjunction with FIGS. 4-7.

User configuration data module 200 stores information related to specific users of cellular system 128. User information includes, but is not limited to, data on particular user's roaming patterns so that PSL logic module 192 can make intelligent predictions to efficiently implement the claimed subject matter. In addition, the disclosed technology may be offered to users as an option and module 200 stores information about whether or not a particular user is enrolled for the option.

PSB_0 155, first introduced above in conjunction with FIG. 2, is a data cache buffer, like PSB_1 171 (FIG. 2), PSB_2 172 (FIG. 2), PSB_3 173 (FIG. 2) and PSB_4 174 (FIG. 2). The difference between buffers 171-174 and PSB_0 155 is that PSB_0 155 is employed by PSL logic 192 as a master copy of buffered data. In other words, buffers 171-174 store a copy of the data stored in PSB_0 155. PSB_0 155 is illustrated, for the purposes of the following description, storing two (2) data caches, i.e. a DC_1 201 and a DC_2 203. Typically, the claimed subject matter would employ many data caches such as DC_1 201 and DC_2 203 but, for the sake of simplicity, only two (2) are shown.

FIG. 4 is a block diagram of PSL client_1 171, first introduced in conjunction with FIG. 2, in more detail. PSL client_1 171 executes on computing logic associated with cellular tower_1 161. (FIG. 2). PSL client_1 171 is similar to PSL client_2 172, PSL client_3 173 and PSL client_4 174, so clients 172-174 are not described separately. PSL client_1 171 includes a PSL client logic module 202, a PSL client configuration data module 204, a PSB Timeout Logic module 206, and PSB_1 181 (FIG. 2).

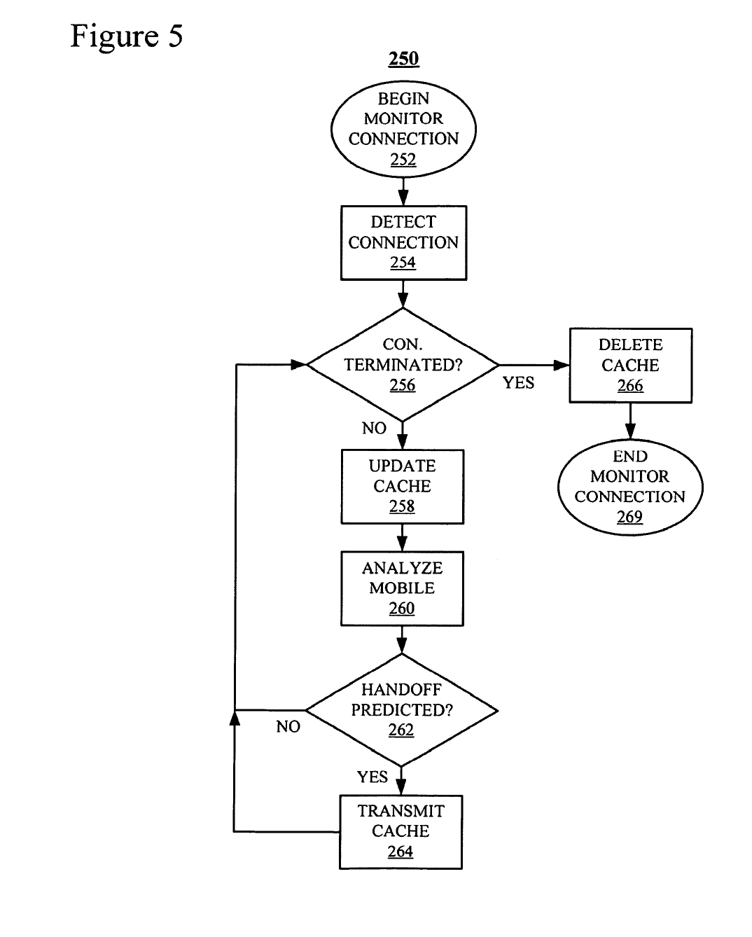

PSL client logic module 202 controls the function of PSL client 171. Module 202 receives data and instructions from PSL server module 154 (FIGS. 2 and 3) and executes code for implementing the claimed subject matter on cellular tower_1 161. The operation of PSL client logic module 202 is described in more detail below in conjunction with FIGS. 5-7.

PSL client configuration data module 204 stores information, or parameters, associated with a particular implementation of the claimed subject matter. One example of a parameter stored in conjunction with data 204 is a timeout parameter, corresponding to the timeout parameter introduced above in conjunction with PSL configuration data module 194 of FIG. 3. The timeout parameter specifies an interval of time that is required to pass before a PSB timeout logic module 206 deletes a particular data cache stored in PSB_1 181. Module 204 also stores such information as, but not limited to, related to optimal buffer cache size.

PSB_1 181 receives data caches employed to implement the claimed subject matter. As explained above in conjunction with PSB_0 155 (FIGS. 2 and 3), PSB_1 receives a copy of data stored in PSB_0 155. In this example, PSB_0 155 is shown storing DC_1 201 (FIG. 3), which is a copy of DC_1 201 stored on PSB_0 155. The use of PSB_1 181 and data caches such as DC_1 201 is described in more detail below in conjunction with FIGS. 5-7.

FIG. 5 is a flowchart of a Monitor Connection process 250 executed by PSL server module 154 of FIGS. 2 and 3 as part of PSL server logic 192 (FIG. 3). In the following description, the claimed subject matter, including process 250, is primarily controlled by computing resources associated with cellular switch 152 (FIG. 2). In the alternative, process 250 and the disclosed technology could be distributed across cellular system 128 (FIGS. 1 and 2) such that the processing of any particular cellular telephone connection, which in the following example is on telephone 132 (FIG. 1), is primarily handled as a computing task associated with the cellular tower 161-164 (FIG. 2) actually handling the connection, i.e. the end relay communication node.

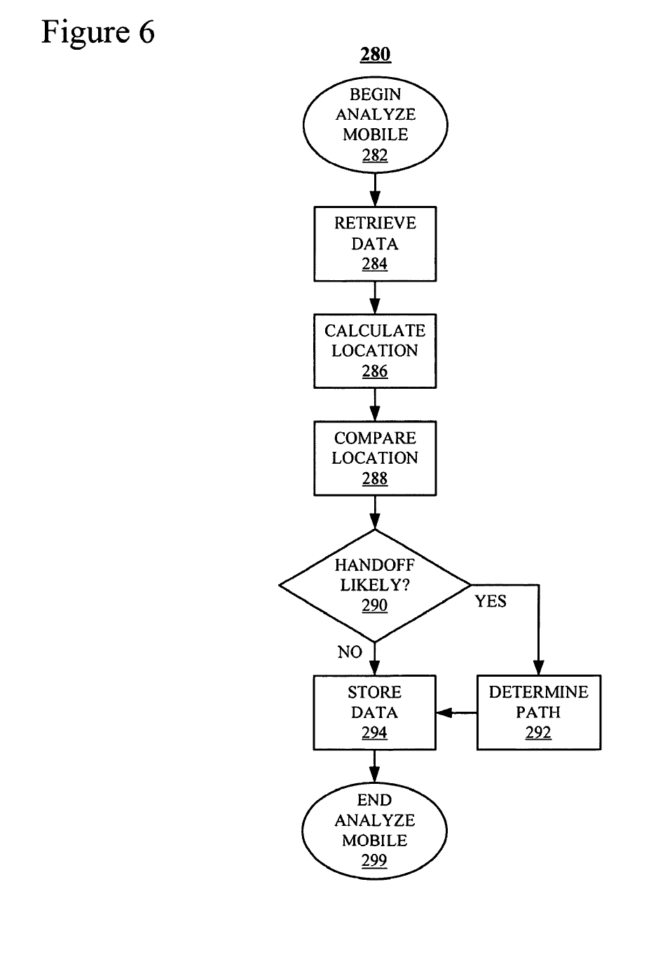

Process 250 starts in a “Begin Monitor Connection” block 252 and proceeds immediately to a “Detect Connection” block 254. During block 254, process 250 detects a particular connection between a cellular telephone and a cellular system. During a “Connection Terminated?” block 256, process 250 determines whether or not the connection detected as previously described (see process block 254) has been terminated. Of course, the first time through block 256, the connection has probably not been terminated because it only just recently commenced. If the connection has not been terminated, process 250 proceeds to an “Update Cache” block 258 during which any requested data associated with the connection is stored in PSB_0 155 (FIGS. 2 and 3). At the same time the data cache is stored in PSB_0 155, the caches is also transmitted and stored in the data buffer associated with the end relay communication node that is currently handling the call, which in this example is PSB_1 181 (FIG. 2) associated with cellular tower_1 161. Examples of data include, but are not limited to, data downloaded from the Internet or data associated with email or graphic programs executing on telephone 132. During an “Analyze Mobile” block 260, process 250 processes data associated with the particular connection to determine any potential roaming patterns. Processing associated with block 260 is described more fully below in conjunction with FIG. 6.

During a “Handoff Predicted?” block 262, process 250 determines whether or not the analysis executed as previously described (see process bock 260) predicts that the connection is likely to select a different communication node as the end relay communication node. In this example, the connection is handled by cellular tower_1 161, i.e. the current end relay communication node, and has the potential to be passed, or handed off, to cellular tower_2 162 (FIG. 2), cellular tower_3 163 (FIG. 2) or cellular tower_4 164 (FIG. 2), i.e. the potential end relay communication node. Information concerning possible handoff patterns and/or possibilities is stored in network configuration data 198 (FIG. 3).

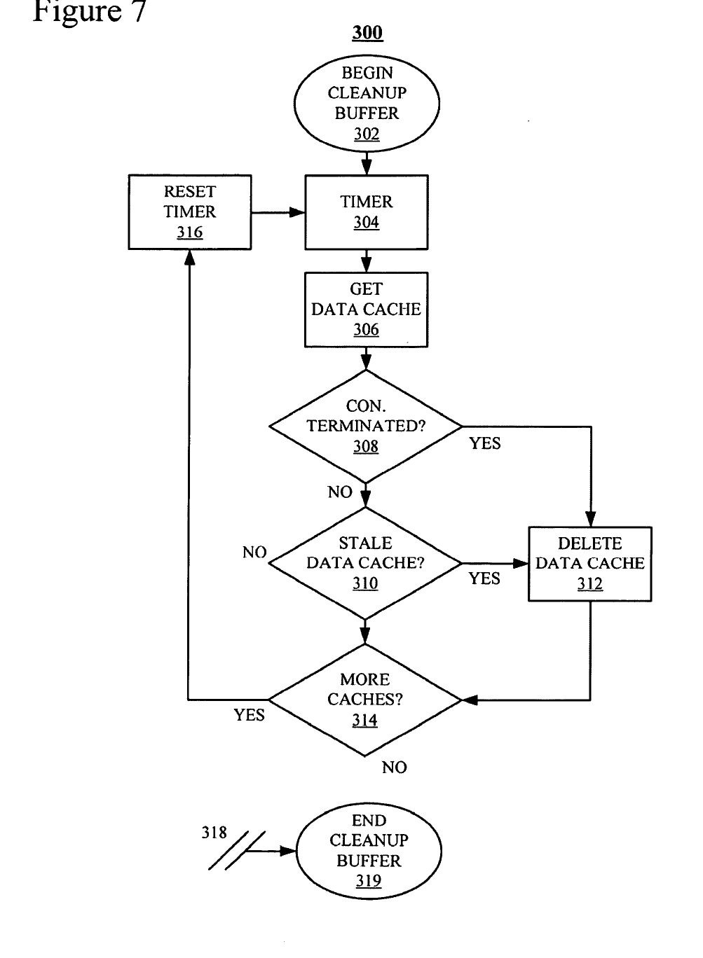

If during block 262, process 250 determines that a handoff is either likely or possible, control proceeds to a “Transmit Cache” block 264. During block 264, the data cache stored in PSB_0 155 as previously described (see process block 258) is transmitted to PSB_2 182 (FIG. 2), PSB_3 183 (FIG. 2) or PSB_4 184 (FIG. 2) of cellular tower_2 162, cellular tower_3 163 or cellular tower_4 164, respectively, depending upon the likely handoff pattern as determined by process 250 (see process block 260). In the alternative, the data cache is transmitted to a number of possible end relay communication nodes, depending upon a calculated likelihood that any particular communication node is to receive the connection. Another alternative is that the data cache is transmitted to all possible end relay communication nodes. Both alternative transmission scenarios enable the processing associated with block 260 to be simpler than in the primary example but increase the complexity of a process that deletes unnecessary data caches (see FIG. 7).

Once the data cache has been transmitted (see process block 264) or, if during block 262, process 250 determines that a handoff is not likely, process 250 returns to Connection Terminated? Block 256 and processing continues as described above. If, during block 256, process 250 determines that the connection detected during block 254 has been terminated, process 250 proceeds to a “Delete Cache” block 266. During block 266, process 250 either deletes or causes to be deleted data caches that are no longer necessary from PBS_0 155, PSB_1 181, PSB_2 182, PSB_3 183 and PSB_4 184. An example of a cache deletion process is described below in conjunction with FIG. 7. Finally, control proceeds to an “End Monitor Connection” block 269 in which process 250 is complete.

FIG. 6 is a flowchart of an Analyze Mobile process 280 executed by PSL server module 154 of FIGS. 2 and 3. Process 280 corresponds to Analyze Mobile block 260 of Monitor Connection process 250, both described above in conjunction with FIG. 5. Like process 250, in this example, process 280 is executed by PSL server module 154 of FIGS. 2 and 3 as part of PSL server logic 192 (FIG. 3). In the following description, the claimed subject matter, including process 280, is primarily controlled by computing resources associated with cellular switch 152 (FIG. 2). In the alternative, process 280 and the disclosed technology could be distributed across cellular system 128 (FIGS. 1 and 2) such that the processing of any particular cellular telephone connection, which in the following example is on telephone 132 (FIG. 1), is primarily handled as a computing task associated with the cellular tower 161-164 (FIG. 2) actually handling the connection as the end relay communication node.

Process 280 starts in a “Begin Analyze Mobile” block 282 and proceeds immediately to a “Retrieve Data” block 284. During block 184, data associated with the particular mobile device, e.g. telephone 132, is retrieved from various sources. Examples of data retrieved include, but are not limited to, PSL configuration data 194 (FIG. 3), network configuration data 198 (FIG. 2), user configuration data 200 (FIG. 3), PSL client configuration data 204 (FIG. 4), global positioning system (GPS) or any other location related information associated with telephone 132 and any data associated with telephone 132 stored during a previous iteration through process 280.

During a “Calculate Location” block 286, process 280 employs GPS or other location-related data to determine a geographical location for telephone 132. During a “Compare Location” block 288, process 280 compares the location determined as previously described (see process block 286) with location data retrieved (see process block 284). During a “Handoff Likely?” block 290, process 280 determines whether or not telephone is moving and, if so, whether or not a handoff from the current end relay communication node, i.e. cellular tower_1 161, to an alternative end relay communication node, i.e. cellular towers 162-164, is likely to occur.

If process 280 determines that a handoff is likely to occur, process 280 proceeds to a “Determine Path” block 292. During block 292, process 280 employs the data retrieved as previously described (see process block 284) and collected (see process block 286) to calculate a potential path for telephone 132 so that process 250 is able to transmit a data cache to the appropriate node or nodes. As described above, the calculation may determine a single most likely handoff location or several locations and the likelihood of a handoff associated with each location, with data caches transmitted to selected likely locations. In the alternative, process 280 may merely calculate all possible end realy communicaiton nodes to enable process 250 to transmit data caches to each.

Once a potential path has been calculated as previously described (see process block 292), or, if during block 290, process 280 has determined that a handoff is not likely, the information processed as previously described (see process blocks 286, 288, 290 and 292) is stored in user configuration data 200 during a “Store Data” block 294. Finally, process 280 proceeds to an “End Analyze Mobile” block 299 in which process 280 is complete.

FIG. 7 is a flowchart of a Cleanup Buffer process 300 executed by PSL server module 154 of FIGS. 2 and 3 and PSL client module 171-174 of FIGS. 2 and 4. In this example, process 300 executes at each communication node or switching site that has a PSB, such as cellular switch 152 (FIG. 2), cellular tower_1 161 (FIG. 2), cellular tower_2 162 (FIG. 2), cellular tower_3 163 (FIG. 2) and cellular tower_4 164 (FIG. 2). Process 300 executes to cleanup data buffers such as PSB_0 155 (FIGS. 2 and 3), PSB_1 181 (FIGS. 2 and 4), PSB_2 182 (FIG. 2), PSB_3 183 (FIG. 2) and PSB_4 184 (FIG. 2), so that data caches, such as DC_1 201 (FIGS. 3 and 4) and DC_2 203 (FIG. 3), that are no longer needed do not remain in data buffers. In this example, process 300 is executing by PSL server module 154 on cellular switch 152.

Process 300 starts in a “Begin Cleanup Buffer” block 302 and proceeds immediately to a “Timer” block 304. During block 304, a timer (not shown) is configured to periodically initiate the execution of the remaining blocks. The specific amount of time between execution of the remaining blocks corresponds to a configurable parameter stored in either a PSL configuration data module, such as module 194 (FIG. 3), or a PSL client configuration data module, such as module 204 (FIG. 4).

Once the time associated with block 304 expires, process 300 proceeds to a “Get Data Cache” block 306. During block 306, process 300 scans PSB_0 155 for the presence of data caches, which in this example would be DC_1 201 and DC_2 203. In this example, the first cache processed is DC_1 201,which becomes the “target” cache. During a “Connection Terminated?” block 308, process 300 examines DC_1 201 for an indication of whether or not the connection associated with DC_1 201 has been terminated, i.e. the associated communication node is no longer designated as the end relay communication node. If the connection has not been terminated, process 300 proceeds to a “Stale Data Cache?” block 310. During block 310, process 300 determines whether or not DC_1 201 has become “stale,” i.e. a time stamp associated with DC_1 201 indicates that DC_1 201 is old enough that the associated connection no longer needs the data stored in DC_1 201. The length of time necessary to define a data cache as stale is stored in a configurable parameter in conjunction with PSL configuration data 194 (FIG. 3).

If the target data cache is determined to be stale (see process block 310) or, if determined to be associated with a terminated connection as previously described (see process block 308), process 300 proceeds to a “Delete Data Cache” block 312. During block 312, process 300 deletes the target data cache 201 from the data buffer. During a “More Caches?” block 314, process 300 determines whether or not there are any more data caches to be processed. In this example, DC_2 203 has not yet been processed, so control returns to block 306, DC_2 203 becomes the target data cache and processing continues as described above. If process 300 determines during block 314 that all data caches have been scanned, control proceed to a “Reset Timer” block 316, where the timer is reset, returns to block 304 and processing continues as described above.

It should be noted that process 300 is designed to operate continuously as long as PSL server module 154 is executing. In the event that module 154 is terminated, an asynchronous interrupt 318 is generated. Interrupt 318 causes control to proceed to an “End Cleanup Buffer” block 319 in which process 300 is complete.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method, comprising:
receiving a request for data from a mobile computing device communicatively coupled for user communication to a first end relay communication node;
generating a data cache corresponding to the request for data;
identifying a potential end relay communication node; and
transmitting the data cache to the potential end relay communication node.

2. The method of claim 1, further comprising:
detecting when the data cache has been completely transmitted to the mobile computing device; and
deleting the data cache from the first end relay communication node and the potential end relay communication node.

3. The method of claim 1, further comprising:
detecting that the potential end relay communication node is handling the user communication; and
deleting the data cache from the first end relay communication node.

4. The method of claim 1, the identifying the potential end relay communication node comprising:
determining a geographical location corresponding to the mobile computing device;
comparing the geographical location to a previously determined geographical location corresponding to the mobile computing device;
calculating future movement of the mobile computing device based upon the comparison; and
selecting the potential end relay communication node based upon the calculated future movement.

5. The method of claim 1, the identifying the potential communication node comprising:
determining a list of possible end relay communication nodes comprising any possible communication node to which the mobile computing device may be communicatively coupled for user communication; and
selecting the potential end relay communication node from the list of possible communication nodes based upon a likelihood that the mobile computing device will be communicatively coupled to the communication node for user communication.

6. The method of claim 5, further comprising selecting a second potential end relay communication node to which to transmit the data cache from the list of possible end relay communication nodes based upon a likelihood that the mobile computing device will be communicatively coupled to the second potential end relay communication node for user communication.

7. The method of claim 1, wherein the mobile computing device is a cellular telephone and the current and potential end relay communication nodes are cellular telephone towers.

8. A system, comprising:
a processor;
a memory coupled to the processor;
a plurality of communication nodes; and
logic, stored on the memory for execution on the processor, for:
receiving a request for data from a mobile computing device communicatively coupled for user communication to first communication node, designated as a current end relay communication node, of the plurality of communication nodes;
generating a data cache corresponding to the request for data;
identifying a potential end relay communication node of the plurality of communication nodes; and
transmitting the data cache to the potential end relay communication node.

9. The system of claim 8, further the logic further comprising logic, stored on the memory for execution on the processor, for:
detecting when the data cache has been completely transmitted to the mobile computing device; and
deleting the data cache from the current end relay communication node and the potential end relay communication node.

10. The system of claim 8, further comprising logic, stored on the memory for execution on the processor, for:
detecting that the potential end relay communication node is handling the user communication; and
deleting the data cache from the current end relay communication node.

11. The system of claim 8, the logic for identifying the potential end relay communication node comprising logic for:
determining a geographical location corresponding to the mobile computing device;
comparing the geographical location to a previously determined geographical location corresponding to the mobile computing device;
calculating future movement of the mobile computing device based upon the comparison; and
selecting the potential end relay communication node based upon the calculated future movement.

12. The system of claim 8, the logic for identifying the potential end relay communication node comprising:
logic for determining a list of possible end relay communication nodes comprising any possible communication node to which the mobile computing device may be communicatively coupled for user communication; and
logic for selecting the potential end relay communication node from the list of possible end relay communication nodes based upon a likelihood that the mobile computing device will be communicatively coupled to the communication node for user communication.

13. The system of claim 12, further comprising logic, stored on the memory for execution on the processor, for:
selecting a second potential end relay communication node to which to transmit the data cache from the list of possible end relay communication nodes; and
transmitting the data cache to the second potential end relay communication node.

14. The system of claim 8, wherein the mobile computing device is a cellular telephone and the current and potential end relay communication nodes are cellular telephone towers.

15. A computer programming product, comprising:
a memory;
logic, stored on the memory for execution on a processor, for receiving a request for data from a mobile computing device communicatively coupled for user communication to first communication node, designated as a current end relay communication node, of the plurality of communication nodes;
logic, stored on the memory for execution on the processor, for generating a data cache corresponding to the request for data;
logic, stored on the memory for execution on the processor, for identifying a potential end relay communication node of the plurality of communication nodes; and
logic, stored on the memory for execution on the processor, for transmitting the data cache to the potential end relay communication node.

16. The computer programming product of claim 15, further comprising:
logic, stored on the memory for execution on the processor, for detecting when the data cache has been completely transmitted to the mobile computing device; and
logic, stored on the memory for execution on the processor, for deleting the data cache from the current end relay communication node and the potential end relay communication node.

17. The computer programming product of claim 15, further comprising:
logic, stored on the memory for execution on the processor, for detecting that the potential end relay communication node is handling the user communication; and
logic, stored on the memory for execution on the processor, for deleting the data cache from the current end relay communication node.

18. The computer programming product of claim 15, the logic for identifying the potential end relay communication node comprising:
logic for determining a geographical location corresponding to the mobile computing device;
logic for comparing the geographical location to a previously determined geographical location corresponding to the mobile computing device;
logic for calculating future movement of the mobile computing device based upon the comparison; and
logic for selecting the potential end relay communication node based upon the calculated future movement.

19. The computer programming product of claim 15, the logic for identifying the potential end relay communication node comprising:
logic for determining a list of possible end relay communication nodes comprising any possible communication node to which the mobile computing device may be communicatively coupled for user communication; and
logic for selecting the potential end relay communication node from the list of possible end relay communication nodes based upon a likelihood that the mobile computing device will be communicatively coupled to the communication node for user communication.

20. The computer programming product of claim 19, further comprising:
logic, stored on the memory for execution on the processor, for selecting a second potential end relay communication node to which to transmit the data cache from the list of possible end relay communication nodes; and
logic, stored on the memory for execution on the processor, for transmitting the data cache to the second potential end relay communication node.
